(19) United States
(12) Patent Application Publication
(10) Pub. No.: US 2023/0129249 A1
(43) Pub. Date: Apr. 27, 2023

(54) BATTERY AND MANUFACTURING METHOD OF THIS BATTERY

(71) Applicant: Prime Planet Energy & Solutions, Inc., Tokyo (JP)

(72) Inventors: Kohei YAMADA, Kobe-shi (JP); Ryoichi WAKIMOTO, Kobe-shi (JP)

(21) Appl. No.: 17/968,795

(22) Filed: Oct. 19, 2022

(30) Foreign Application Priority Data
Oct. 22, 2021 (JP) 2021-172790

(51) Int. Cl. H01M 10/0587; H01M 10/0525; H01M 50/186; H01M 50/103

(52) U.S. Cl. CPC H01M 10/0587; H01M 10/0525; H01M 50/186; H01M 50/103

(57) ABSTRACT

A battery whose reliability is suitably enhanced and a manufacturing method of the battery are provided. The manufacturing method of the battery herein disclosed includes a fitting step for abutting at least a portion of an outer package and a sealing plate, and deforming the outer package and/or the sealing plate so as to fit the outer package and the sealing plate, and a joining step for joining the outer package and the sealing plate.

### CROSS REFERENCE TO RELATED APPLICATIONS

The present application claims the priority based on Japanese Patent Application No. 2021-172790 filed on, Oct. 22, 2021, the entire contents of which are incorporated in the present specification by reference.

### BACKGROUND

The present disclosure relates to a battery and a manufacturing method of the battery.

A battery, such as a lithium ion secondary battery, generally includes an electrode body that is provided with an electrode and includes a battery case that accommodates the electrode body. The battery case as described above typically includes an outer package that has an opening part and is configured to accommodate the electrode body, and includes a sealing plate that is configured to seal the opening part of the outer package. For example, Japanese Patent Application Publication No. 2013-093119 discloses a battery case having a configuration as described above.

### SUMMARY

Anyway, a battery case as described above is formed, for example, by fitting a sealing plate into an outer package, and then joining a peripheral edge of the sealing plate. However, if only this kind of fitting is performed, a position of the sealing plate with respect to the outer package tends to be hardly fixed, and thus the sealing plate might be moved. In that case, it becomes difficult to implement stable joining. Additionally, in a case where a gap is caused between the outer package and the sealing plate by movement of the sealing plate, a microscopic metal (so called sputter) generated at the time of joining, or the like might enter from the gap into the outer package so as to reduce a battery performance, and thus it is not preferable.

The present disclosure has been made in view of the above-described circumstances, and the main purpose is to provide a battery whose reliability is suitably enhanced and to provide a manufacturing method of the battery.

In order to satisfy the purpose as described above, the present disclosure provides a manufacturing method of a battery that includes one or a plurality of electrode bodies each provided with a positive electrode and a negative electrode, and a battery case that is configured to accommodate said electrode body and that includes an outer package and a sealing plate configured to seal an opening part of said outer package. The manufacturing method of the battery as described above includes a fitting step for abutting at least one portion of said outer package and said sealing plate and for deforming said outer package and/or said sealing plate so as to fit said outer package and said sealing plate, and a joining step for joining said outer package and said sealing plate.

In the manufacturing method of the battery described above, at a fitting step, at least one portion of an outer package and a sealing plate are abutted and an outer package or a sealing plate is deformed so as to fit an outer package and a sealing plate. By doing this, a position of the sealing plate with respect to the outer package can be suitably fixed, and thus it is possible to perform stable joining. In addition, by fixing as described above, it is possible to inhibit the sputter, or the like, capable of being generated at the time of joining, from entering into the outer package, and thus it is possible to suitably inhibit reduction in the battery performance caused by the sputter. Therefore, according to the above-described manufacturing method of the battery, it is possible to obtain the battery whose reliability is suitably enhanced.

In one aspect of the manufacturing method of the battery herein disclosed, said outer package includes a bottom wall, a pair of first side walls that extend from said bottom wall and are opposed mutually, a pair of second side walls that extend from said bottom wall and are opposed mutually, and an opening part that is opposed to said bottom wall, an area of said first side wall is larger than said second side wall, and said sealing plate is formed in a rectangular shape.

In one suitable aspect of the manufacturing method of the battery, at said fitting step, at least a portion of said sealing plate is arranged inside said opening part of said outer package so as to perform said fitting, and at said joining step, said outer package and said sealing plate are joined while said pair of first side walls are pressed to an inside of said outer package. Regarding the battery including the outer package in which an area of the first side wall is larger than an area of the second side wall (for example, outer package including a rectangular opening part), as an example of a method for obtaining a battery whose reliability is enhanced, a method can be used that performs joining while inhibiting generation of gap at the join part with the outer package and the sealing plate on the side of long side of the opening part. Therefore, at the joining step, the outer package and the sealing plate are joined while the pair of first side walls are pressed to the inside of the outer package, and it is effective from a perspective of obtaining a battery whose reliability is more suitably enhanced.

In one suitable aspect of the manufacturing method of the battery herein disclosed, at said fitting step, said outer package and said sealing plate are fit on at least a side of short side of said rectangular sealing plate. For example, as described above, when the pair of first side walls are pressed to the inside of the outer package, the outer package might happen to be deformed and then a gap might happen to be caused at the side of short side of the opening part of the outer package. In that case, there is a fear that the sputter, or the like, caused at the time of joining, enters from the gap into the outer package. On the other hand, as described above, when the outer package and the sealing plate are fit on at least the side of short side of the sealing plate, it becomes hard to cause the gap as described above at the side of short side of the outer package, and thus it is possible to suitably inhibit the sputter from entering into the outer package. By doing this, it is possible to obtain the battery whose reliability is more suitably enhanced.

In one aspect of the manufacturing method of the battery herein disclosed, any one among said at least one portion of said outer package and said sealing plate to be abutted includes a R surface or a C surface, and other one to be abutted includes a corner part for deforming said R surface or said C surface.

In one aspect of the manufacturing method of the battery as described above, said R surface or said C surface exists at a portion opposed to said bottom wall on said sealing plate.

In one aspect of the manufacturing method of the battery as described above, a step part including said corner part exists at a vicinity of said opening part on said outer package.

In one suitable aspect of the manufacturing method of the battery as described above, at said fitting step, said at least one portion of said outer package and said sealing plate are abutted to make an acute angle, defined by a direction in which said bottom wall extends and by a tangential line at a portion where said R surface or said C surface and said corner part come into contact with each other, be within a range of 10° to 45°. Although the details will be described later, according to the manufacturing method of the battery including the configuration as described above, it is possible to obtain the battery whose reliability is more suitably enhanced.

In one suitable aspect of the manufacturing method of the battery as described above, at said fitting step, a fit part is formed, and said fit part includes a recessed part formed by said corner part to make a depth in a thickness direction of said sealing plate be within a range of 0.01 mm to 0.3 mm Although the details will be described later, according to the manufacturing method of the battery including the configuration as described above, it is possible to obtain the battery whose reliability is more suitably enhanced.

In addition, from another aspect, a battery is provided which is manufactured by any of the herein disclosed manufacturing methods of the battery. The battery as described above includes one or a plurality of electrode bodies, each provided with a positive electrode and a negative electrode, and a battery case configured to accommodate said electrode body, and provided with an outer package and a sealing plate that is configured to seal an opening part of said outer package, a fit part exists in which any one among at least one portion of said outer package and at least one portion of said sealing plate is bitten by other one, and said outer package and said sealing plate are joined.

In one aspect of the battery herein disclosed, a padding part exists at a vicinity of said fit part of the bitten one among said at least one portion of said outer package or said at least one portion of said sealing plate.

In one aspect of the battery herein disclosed, said fit part includes a recessed part, and an acute angle defined by a direction in which said bottom wall extends and by a tangential line at said recessed part is within a range of 10° to 45°.

In one aspect of the battery herein disclosed, said fit part includes a recessed part in which a depth in a thickness direction of said sealing plate is within a range of 0.01 mm to 0.3 mm.

### BRIEF DESCRIPTION OF THE DRAWINGS

FIG. 1 is a perspective view that schematically shows a battery in accordance with Embodiment 1.

FIG. 2 is a longitudinal cross section view that is schematically shown along a II-II line of FIG. 1.

FIG. 3 is a longitudinal cross section view that is schematically shown along a line of FIG. 1.

FIG. 4 is a lateral cross section view that is schematically shown along a IV-IV line of FIG. 1.

FIG. 5 is a perspective view that schematically shows an electrode body group attached to a sealing plate.

FIG. 6 is a perspective view that schematically shows an electrode body to which a positive electrode second electrical collector part and a negative electrode second electrical collector part are attached.

FIG. 7 is a schematic view that shows a configuration of a wound electrode body.

FIG. 8 is a flowchart for explaining about a manufacturing method of a battery in accordance with Embodiment 1.

FIG. 9 is a perspective view that schematically shows an outer package used in the manufacturing method of the battery in accordance with Embodiment 1.

FIG. 10 is a perspective view that schematically shows the sealing plate to which a positive electrode terminal, a negative electrode terminal, a positive electrode first electrical collector part, a negative electrode first electrical collector part, a positive electrode inside insulating member, and a negative electrode inside insulating member are attached.

FIG. 11 is a perspective view in which the sealing plate of FIG. 10 is reversed.

FIG. 12A is a cross sectional view that is schematically shown for explaining about abutting of a portion of the outer package and the sealing plate at a fitting step of the manufacturing method of the battery in accordance with Embodiment 1. It is a longitudinal cross section view that schematically shows an aspect before fitting of FIG. 12C.

FIG. 12B is a cross sectional view that is schematically shown for explaining about fitting of a portion of the outer package and the sealing plate at the fitting step of the manufacturing method of the battery in accordance with Embodiment 1. It is a longitudinal cross section view that schematically shows an aspect before joining of FIG. 12C.

FIG. 12C is a longitudinal cross section view that is schematically shown along a XII-XII line of FIG. 1.

FIG. 13 is a schematic view for explaining about a joining step in accordance with Embodiment 1.

FIG. 14A is a FIG. 12A corresponding view in accordance with Embodiment 2.

FIG. 14B is a FIG. 12B corresponding view in accordance with Embodiment 2.

FIG. 15A is a FIG. 12A corresponding view in accordance with Embodiment 3.

FIG. 15B is a FIG. 12B corresponding view in accordance with Embodiment 3.

### DETAILED DESCRIPTION

Below, while referring to drawings, some preferred embodiments of herein disclosed techniques will be explained. Incidentally, the matters other than matters particularly mentioned in this specification, and required for practicing the present disclosure (for example, a general configuration and manufacturing process for the battery by which the present disclosure is not characterized) can be grasped as design matters of those skilled in the art based on the conventional technique in the present field. The present disclosure can be executed based on the contents disclosed in the present specification, and the technical common sense in the present field. The below described explanation is not intended to restrict the herein disclosed technique to the below described embodiment. Additionally, in the present specification, a phrase “A to B” representing a numerical value range means a matter being equal to or more than A and not more than B. Therefore, it semantically covers a case of being more than A and less than B.

Incidentally, in the present specification, the “battery” is a term widely denoting an electric storage device capable of taking out the electric energy, and is a concept containing the primary battery and the secondary battery. In addition, in the present specification, the “secondary battery” is a term widely denoting an electric storage device capable of repeatedly charging and discharging, and is a concept containing so called storage batteries (chemical batteries), such as a lithium ion secondary battery and a nickel hydrogen battery, and containing capacitors (physical batteries), such as an electric double layer capacitor.

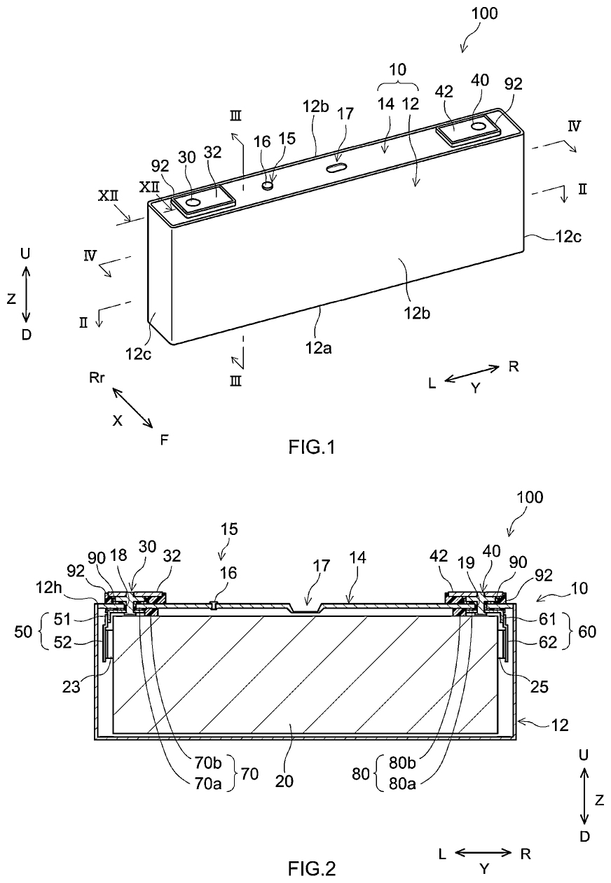

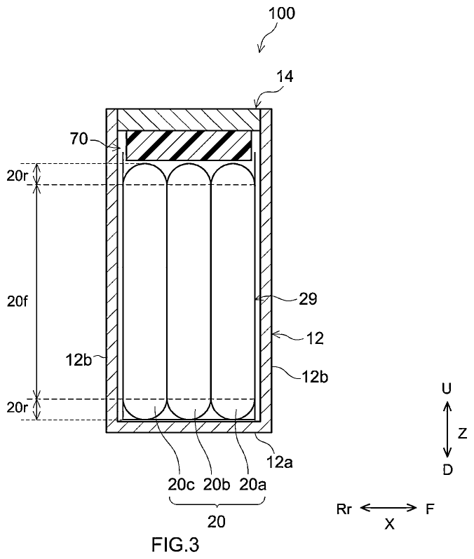

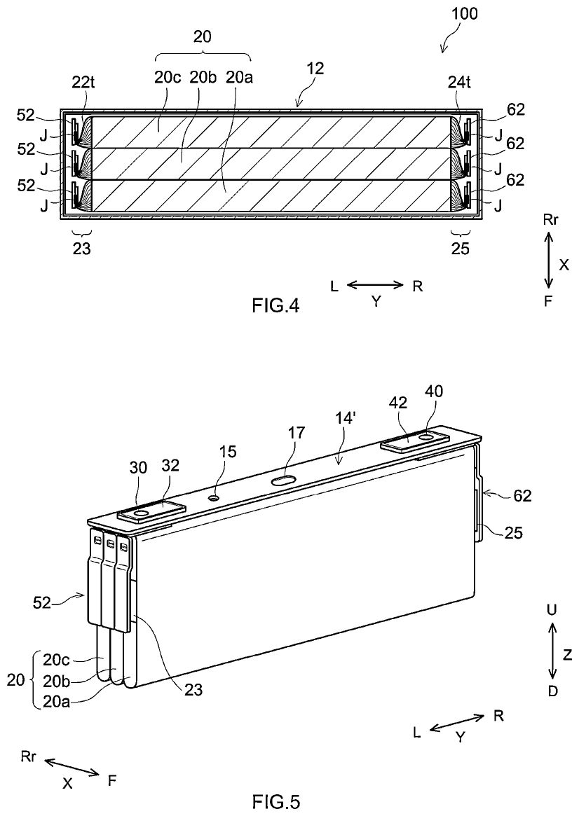

At first, a configuration of a battery 100 obtained by a manufacturing method of the battery in accordance with the present embodiment will be described. FIG. 1 is a perspective view of the battery 100. FIG. 2 is a longitudinal cross section view that is schematically shown along a II-II line of FIG. 1. FIG. 3 is a longitudinal cross section view that is schematically shown along a line of FIG. 1. FIG. 4 is a lateral cross section view that is schematically shown along a IV-IV line of FIG. 1. In the explanation described below, reference signs L, R, F, Rr, U, and D in drawings respectively represent left, right, front, rear, up, and down, and reference signs X, Y, and Z in drawings respectively represent a short side direction, a long side direction orthogonal to the short side direction, and a vertical direction of the battery 100. However, these are merely directions for convenience sake of explanation, which never restrict the disposed form of the battery 100.

As shown in FIG. 2, the battery 100 includes a battery case 10 and an electrode body 20. In addition, the battery 100 in accordance with the present embodiment includes not only the battery case 10 and the electrode body 20, but also a positive electrode terminal 30, a positive electrode outside conductive member 32, a negative electrode terminal 40, a negative electrode outside conductive member 42, an outside insulating member 92, a positive electrode electrical collector part 50, a negative electrode electrical collector part 60, a positive electrode inside insulating member 70, and a negative electrode inside insulating member 80. In addition, as the illustration is omitted, the secondary battery 100 in accordance with the present embodiment further includes an electrolyte. The battery 100 here is a lithium ion secondary battery. An inside resistance of the battery 100 could be, for example, about 0.2 to 2.0 mΩ.

Then, the battery case 10 includes an outer package 12, a sealing plate 14, and a gas exhaust valve 17. The outer package 12 is a container formed in a flat square shape whose one surface is an opening part 12h. In particular, as shown in FIG. 1, the outer package 12 includes a bottom wall 12a that is formed in an approximately rectangular shape, a pair of first side walls 12b that extend upward U from a short side of the bottom wall 12a and that are opposed mutually, and a pair of second side walls 12c that extend upward U from a long side of the bottom wall 12a and that are opposed mutually. An area of the first side wall 12b is larger than an area of the second side wall 12c. Then, the opening part 12h is formed at an upper surface of the outer package 12 surrounded by the above-described pair of first side walls 12b and the above-described pair of second side walls 12c. The opening part 12h includes a short side 12d and a long side 12e. The sealing plate 14 is attached to the outer package 12 so as to cover the opening part 12h of the outer package 12. The sealing plate 14 is a plate member formed to have an approximately rectangular shape in a plane view. The sealing plate 14 includes a short side 14d and a long side 14e. The sealing plate 14 is opposed to the bottom wall 12a of the outer package 12. The battery case 10 is formed by joining (for example, welding-joining) the sealing plate 14 to a peripheral edge of the opening part 12h of the outer package 12. Joining the sealing plate 14 can be performed, for example, by welding, such as laser welding. Incidentally, configurations of the outer package 12 and the sealing plate 14 included by the battery 100 in accordance with the present embodiment will be described later.

Although details will be described later, in the present embodiment, at least a portion of the outer package 12 (for more details, outer package 12′ before fitting) and at least a portion of the sealing plate 14 (for more details, sealing plate 14′ before fitting) are abutted and the outer package is bitten into the sealing plate, so as to perform fitting. Although not particularly restricted to this, it is preferable in this case, for example, that a material configuring the outer package 12 is harder than a material configuring the sealing plate 14. As an example of material configuring the outer package 12, it is possible to use aluminum or aluminum alloy (for example, A1050-H18, A3003-H18, or the like), a material in which a plastic processing is performed on the aluminum or the aluminum alloy (for example, A1050-O, or A3003-O) and molding is performed to induce work hardening, or the like. As an example of a material configuring the sealing plate 14, it is possible to use aluminum or aluminum alloy (for example, A1050-O, or A3003-O), or the like. Incidentally, in a perspective of enhancing processability, it is possible to suitably add a microscopic element (for example, Fe or the like) to a configuration material. In addition, Brinell hardnesses (HB) of the materials configuring the outer package 12 and the sealing plate 14, which are not particularly restricted if the effects of the technique herein disclosed are implemented, can be approximately equal to or more than 10, and can be, from a perspective of suitably securing a mechanical strength of the battery case 10, preferably equal to or more than 20, more preferably equal to or more than 30, or furthermore preferably equal to or more than 40. In addition, from a perspective of facilitating a fitting step described later, the Brinell hardnesses (HB) of the materials configuring the outer package 12 and the sealing plate 14 are approximately equal to or less than 100, and can be preferably equal to or less than 90. In addition, a difference of the above-described Brinell hardnesses of materials configuring the outer package 12 and the sealing plate 14 can be about approximately 20 to 50 (for example, about 25 to 45). However, the values of Brinell hardnesses are not restricted to them. Incidentally, as the above-described Brinell hardnesses, it is possible to use a value based on, for example, JIS_Z_2243.

In addition, thicknesses in thickness directions of the outer package 12 and the sealing plate 14 (below, each is simply referred to as “thickness”, too) are not particularly restricted if the effects of the technique herein disclosed are implemented. From a perspective of increasing an inside volume of the battery 100 and implementing light weight of the battery, it is preferable that the thickness of the outer package 12 is smaller. In addition, it is preferable that the sealing plate 14, which is at a side of being deformed in the later-described fitting step, has a superior mechanical strength (in other words, the thickness is larger). Thus, it is preferable to make the thickness of the outer package 12 be smaller than the thickness of the sealing plate 14. These thicknesses can be suitably planed, on the basis of the kinds of the materials configuring the outer package and the sealing plate, use form, or the like. This kind of plan can be implemented for a person skilled in the art by performing a test, or the like.

As shown in FIG. 1 and FIG. 2, the gas exhaust valve 17 is formed on the sealing plate 14. The gas exhaust valve 17 is configured to be opened when a pressure inside the battery case 10 becomes equal to or more than a predetermined value, and to exhaust gas that exists inside the battery case 10. Further, on the sealing plate 14, a liquid injection hole 15 and two terminal insert holes 18, 19 are provided in addition to the gas exhaust valve 17. The liquid injection hole 15 communicates with an internal space of the outer package 12 and is an opening provided for performing liquid injection of the electrolyte at a manufacturing step of the battery 100. The liquid injection hole 15 is sealed by a sealing member 16. As the sealing member 16 described above, for example, a blind rivet is suitable. By doing this, it is possible to firmly fix the sealing member 16 at the inside of the battery case 10.

FIG. 5 is a perspective view that schematically shows an electrode body group 20 attached to the sealing plate 14′ before fitting (below, simply referred to as “sealing plate 14′”, too). In the present embodiment, a plurality of (here, three) electrode bodies 20a, 20b, 20c are accommodated inside the battery case 10. Incidentally, the number of the electrode bodies accommodated inside the battery case 10 is not particularly restricted, and might be 1 or might be equal to or more than 2 (plural). As shown in FIG. 2, a positive electrode electrical collector part 50 is arranged at one side (left side in FIG. 2) in a long side direction Y of each electrode body 20 and a negative electrode electrical collector part 60 is arranged at the other side (right side in FIG. 2) in the long side direction Y. Then, each of the electrode bodies 20a, 20b, 20c is connected in parallel. However, the electrode bodies 20a, 20b, 20c might be connected in series. The electrode body 20 is accommodated inside the outer package 12 of the battery case 10 in a state of being covered by an electrode body holder 29 (see FIG. 3) made of resin sheet here.

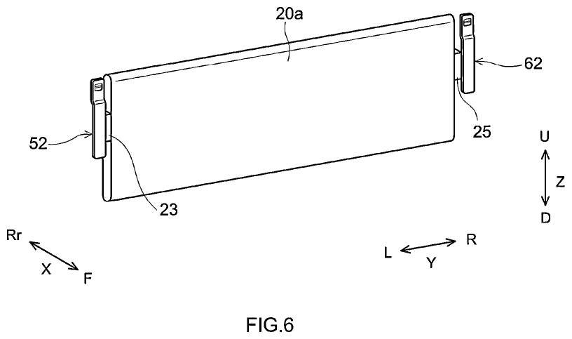

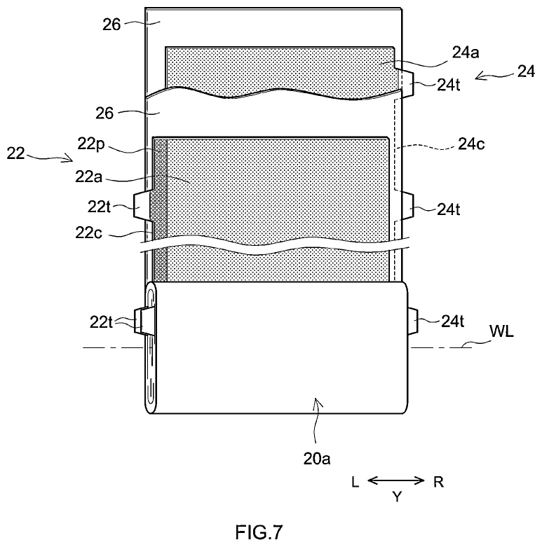

FIG. 6 is a perspective view that schematically shows the electrode body 20a. FIG. 7 is a schematic view that shows a configuration of the electrode body 20a. Incidentally, although details will be explained below with the electrode body 20a used as an example, similar configuration can be applied to the electrode bodies 20b, 20c.

As shown in FIG. 7, the electrode body 20a includes a positive electrode 22, a negative electrode 24, and a separator 26. The electrode body 20a here is a wound electrode body in which a positive electrode 22 formed in a strip-like shape and a negative electrode 24 formed in a strip-like shape are laminated via two strip-like shaped separators 26 and wound therein about a winding axis WL being as a center. However, the structure of the electrode body does not restrict the technique herein disclosed. For example, the electrode body might be a laminate electrode body in which a plurality of square shaped (typically, rectangular) positive electrodes and a plurality of square shaped (typically, rectangular) negative electrodes are stacked in a state of being insulated.

The electrode body 20a has a flat shape. The electrode body 20a is arranged inside the outer package 12 with the winding axis WL being in a direction approximately parallel to the long side direction Y. In particular, as shown in FIG. 3, the electrode body 20a includes a pair of bent parts (R parts) 20r that are opposed to the bottom wall 12a of the outer package 12 and the sealing plate 14, and includes a flat part 20f that couples the pair of bent parts 20r and is opposed to the second side wall 12c of the outer package 12. The flat part 20f is configured to extend along the second side wall 12c.

As shown in FIG. 7, the positive electrode 22 includes a positive electrode electrical collector body 22c, and a positive electrode active material layer 22a and a positive electrode protective layer 22p, each of which is fixed at least one surface of the positive electrode electrical collector body 22c. However, the positive electrode protective layer 22p is not essential, and might be omitted in another embodiment. The positive electrode electrical collector body 22c is formed in a strip-like shape. The positive electrode electrical collector body 22c, for example, consists of an electrically conductive metal, such as aluminum, aluminum alloy, nickel, and stainless steel. The positive electrode electrical collector body 22c here is a metal foil, in particular, an aluminum foil.

At one end part (left end part in FIG. 7) in the long side direction Y of the positive electrode electrical collector body 22c, a plurality of positive electrode tabs 22t are provided. The plurality of positive electrode tabs 22t are provided at intervals (intermittently) along a longitudinal direction of the strip-like shaped positive electrode 22. The plurality of positive electrode tabs 22t protrude, toward one side (left side in FIG. 7) in an axial direction of the winding axis WL, to an outside more than the separator 26. Incidentally, the positive electrode tabs 22t might be provided at the other side (right side in FIG. 7) in the axial direction of the winding axis WL, or might be provided at both sides in the axial direction of the winding axis WL. The positive electrode tab 22t is a part of the positive electrode electrical collector body 22c and consists of a metal foil (aluminum foil). However, the positive electrode tab 22t might be a member different from the positive electrode electrical collector body 22c. On at least a part of the positive electrode tab 22t, an area is formed where the positive electrode electrical collector body 22c is exposed as the positive electrode active material layer 22a and the positive electrode protective layer 22p are not formed.

As shown in FIG. 4, the plurality of positive electrode tabs 22t are laminated at one end part (left end part in FIG. 4) in the axial direction of the winding axis WL so as to configure a positive electrode tab group 23. Then, the plurality of positive electrode tabs 22t are folded and bent to align their outer side ends. By doing this, it is possible to enhance accommodation property to the battery case 10 so as to implement miniaturizing the battery 100. As shown in FIG. 2, the positive electrode tab group 23 is electrically connected to the positive electrode terminal 30 via the positive electrode electrical collector part 50. In particular, the positive electrode tab group 23 and the positive electrode second electrical collector part 52 are connected at a connecting part J (see FIG. 4). Then, the positive electrode second electrical collector part 52 is electrically connected to the positive electrode terminal 30 via the positive electrode first electrical collector part 51. Incidentally, sizes of the plurality of positive electrode tabs 22t (length along the long side direction Y and width orthogonal to the long side direction Y, see FIG. 7) can be suitably adjusted in consideration of a state of being connected to the positive electrode electrical collector part 50, for example, in consideration of the formed position, or the like. Here, respective sizes of the plurality of positive electrode tabs 22t are mutually different to align the outer side ends of bent positive electrode tabs.

As shown in FIG. 7, the positive electrode active material layer 22a is provided in a strip-like shape along the longitudinal direction of the strip-like shaped positive electrode electrical collector body 22c. The positive electrode active material layer 22a contains a positive electrode active substance (for example, lithium transition metal composite oxide, such as lithium-nickel-cobalt-manganese composite oxide) that can reversibly store and release a charge carrier. When a total solid content of the positive electrode active material layer 22a is treated as 100 mass %, the positive electrode active substance might occupy approximately 80 mass % or more, typically 90 mass % or more, or for example, 95 mass % or more. The positive electrode active material layer 22a might contain an arbitrary component other than the positive electrode active substance, for example, an electrical conducting material, a binder, various additive components, or the like. As the electrical conducting material, for example, a carbon material, such as acetylene black (AB), can be used. As the binder, for example, polyvinylidene fluoride (PVdF), or the like can be used.

The positive electrode protective layer 22p is, as shown in FIG. 7, provided at a boundary portion between the positive electrode electrical collector body 22c and the positive electrode active material layer 22a in the long side direction Y. The positive electrode protective layer 22p here is provided at one end part (left end part in FIG. 7) in the axial direction of the winding axis WL of the positive electrode electrical collector body 22c. However, the positive electrode protective layer 22p might be provided at both end parts in the axial direction. The positive electrode protective layer 22p is provided in a strip-like shape along the positive electrode active material layer 22a. The positive electrode protective layer 22p contains an inorganic filler (for example, alumina). When a total solid content of the positive electrode protective layer 22p is treated as 100 mass %, the inorganic filler might occupy approximately 50 mass % or more, typically 70 mass % or more, or for example, 80 mass % or more. The positive electrode protective layer 22p might contain an arbitrary component other than the inorganic filler, for example, an electrical conducting material, a binder, various additive components, or the like. The electrical conducting material and the binder might be the same as ones illustrated as components capable of being contained in the positive electrode active material layer 22a.

As shown in FIG. 7, the negative electrode 24 includes a negative electrode electrical collector body 24c, and a negative electrode active material layer 24a that is fixed on at least one surface of the negative electrode electrical collector body 24c. The negative electrode electrical collector body 24c is formed in a strip-like shape. The negative electrode electrical collector body 24c consists of, for example, an electrically conductive metal, such as copper, copper alloy, nickel, and stainless steel. The negative electrode electrical collector body 24c here is a metal foil, in particular, a copper foil.

At one end part (right end part in FIG. 7) in the axial direction of the winding axis WL of the negative electrode electrical collector body 24c, a plurality of negative electrode tabs 24t are provided. The plurality of negative electrode tabs 24t are provided at intervals (intermittently) along a longitudinal direction of the strip-like shaped negative electrode 24. Each of the plurality of negative electrode tabs 24t protrudes, toward one side (right side in FIG. 7) in an axial direction, to an outside more than the separator 26. However, the negative electrode tabs 24t might be provided at the other end part (left end part in FIG. 7) in the axial direction, or might be provided at both end parts in the axial direction. The negative electrode tab 24t is a part of the negative electrode electrical collector body 24c and consists of a metal foil (copper foil). However, the negative electrode tab 24t might be a member different from the negative electrode electrical collector body 24c. On at least a part of the negative electrode tab 24t, an area is provided where the negative electrode electrical collector body 24c is exposed as the negative electrode active material layer 24a is not formed.

As shown in FIG. 4, the plurality of negative electrode tabs 24t are laminated at one end part (right end part in FIG. 4) in the axial direction so as to configure a negative electrode tab group 25. It is preferable that the negative electrode tab group 25 is provided at a position symmetrical in the axial direction to the positive electrode tab group 23. Then, the plurality of negative electrode tabs 24t are folded and bent to align their outer side ends. By doing this, it is possible to enhance accommodation property to the battery case 10, so as to implement miniaturizing the battery 100. As shown in FIG. 2, the negative electrode tab group 25 is electrically connected to the negative electrode terminal 40 via the negative electrode electrical collector part 60. In particular, the negative electrode tab group 25 and the negative electrode second electrical collector part 62 are connected at the connecting part J (see FIG. 4). Then, the negative electrode second electrical collector part 62 is electrically connected to the negative electrode terminal 40 via the negative electrode first electrical collector part 61. Similarly to the plurality of positive electrode tabs 22t, respective sizes of the plurality of negative electrode tabs 24t are mutually different to align the outer side ends of bent negative electrode tabs.

As shown in FIG. 7, the negative electrode active material layer 24a is provided in a strip-like shape along the longitudinal direction of the strip-like shaped negative electrode electrical collector body 24c. The negative electrode active material layer 24a contains a negative electrode active substance (for example, carbon material, such as graphite) that can reversibly store and release a charge carrier. When a total solid content of the negative electrode active material layer 24a is treated as 100 mass %, the negative electrode active substance might occupy approximately 80 mass % or more, typically 90 mass % or more, or for example, 95 mass % or more. The negative electrode active material layer 24a might contain an arbitrary component other than the negative electrode active substance, for example, a binder, a dispersing agent, various additive components, or the like. As the binder, for example, rubbers, such as styrene butadiene rubber (SBR) can be used. As the dispersing agent, for example, celluloses, such as carboxymethyl cellulose (CMC) can be used.

The separator 26 is, as shown in FIG. 7, a member that establishes an insulation on the positive electrode active material layer 22a of the positive electrode 22, and the negative electrode active material layer 24a of the negative electrode 24. As the separator 26, for example, it is suitable to use a porous sheet made of resin consisting of polyolefin resin, such as polyethylene (PE) and polypropylene (PP). The separator 26 might include a base material part consisting of a porous sheet made of resin, and a heat resistance layer (HRL) provided on at least one surface of the base material part and containing an inorganic filler. As the inorganic filler, for example, it is possible to use alumina, boehmite, water oxidation aluminum, titania, or the like.

The electrolyte might be similar to conventional one, and is not particularly restricted. The electrolyte is, for example, a nonaqueous electrolyte containing a nonaqueous type solvent and a supporting salt. The nonaqueous type solvent contain, for example, carbonates, such as ethylene carbonate, dimethyl carbonate, and ethyl methyl carbonate. The supporting salt is, for example, a fluorine-containing lithium salt, such as LiPF₆. However, the electrolyte might be in a solid shape (solid electrolyte) and might be integrated with the electrode body 20.

The positive electrode terminal 30 is, as shown in FIG. 2, inserted into a terminal insert hole 18 that is formed at one end part (left end part in FIG. 2) in a long side direction Y of the sealing plate 14. It is preferable that the positive electrode terminal 30 is made of metal, and it is more preferable that the positive electrode terminal is made of, for example, aluminum or aluminum alloy. On the other hand, the negative electrode terminal 40 is inserted into a terminal insert hole 19 that is formed at the other end part (right end part in FIG. 2) in the long side direction Y of the sealing plate 14. Incidentally, it is preferable that the negative electrode terminal 40 is made of metal, and it is more preferable that the negative electrode terminal is made of, for example, copper or copper alloy. These electrode terminals (positive electrode terminal 30, and negative electrode terminal 40) here protrude from the same surface (in particular, sealing plate 14) of the battery case 10. However, the positive electrode terminal 30 and the negative electrode terminal 40 might respectively protrude from different surfaces of the battery case 10. In addition, it is preferable that the electrode terminals (positive electrode terminal 30, and negative electrode terminal 40) inserted into the terminal insert holes 18, 19 are fixed to the sealing plate 14 by a caulking process or the like.

As described above, the positive electrode terminal 30 is, while shown in FIG. 2, electrically connected to the positive electrode 22 (see FIG. 7) of each electrode body 20 via the positive electrode electrical collector part 50 (positive electrode first electrical collector part 51, and positive electrode second electrical collector part 52) inside the outer package 12. The positive electrode terminal 30 is insulated from the sealing plate 14 by the positive electrode inside insulating member 70 and the gasket 90. Incidentally, the positive electrode inside insulating member 70 includes a base part 70a disposed between the positive electrode first electrical collector part 51 and the sealing plate 14, and includes a protrude part 70b. Then, the positive electrode terminal 30 exposed to the outside of the battery case 10 through the terminal insert hole 18 is connected to the positive electrode outside conductive member 32 at the outside of the sealing plate 14. On the other hand, the negative electrode terminal 40 is, as shown in FIG. 2, electrically connected to the negative electrode 24 (see FIG. 7) of each electrode body 20 via the negative electrode electrical collector part 60 (negative electrode first electrical collector part 61, and negative electrode second electrical collector part 62) inside the outer package 12. The negative electrode terminal 40 is insulated from the sealing plate 14 by the negative electrode inside insulating member 80 and the gasket 90. Incidentally, similarly to the positive electrode inside insulating member 70, the negative electrode inside insulating member 80 also includes a base part 80a disposed between the negative electrode first electrical collector part 61 and the sealing plate 14, and includes a protrude part 80b. Then, the negative electrode terminal 40 exposed to the outside of the battery case 10 through the terminal insert hole 19 is connected to the negative electrode outside conductive member 42 at the outside of the sealing plate 14. Then, between the above described outside conductive member (positive electrode outside conductive member 32, and negative electrode outside conductive member 42) and the sealing plate 14, the outside insulating member 92 is disposed. By the outside insulating member 92 as described above, it is possible to insulate the outside conductive members 32, 42 and the sealing plate 14.

Next, the manufacturing method of the battery in accordance with the present embodiment will be described. However, it is not intended that the herein disclosed manufacturing method of the battery is restricted to the below described manufacturing method of the battery. The herein disclosed manufacturing method of the battery might further include a different step, as needed. In addition, the order of the steps might be changed suitably, if the effects of the technique herein disclosed are implemented.

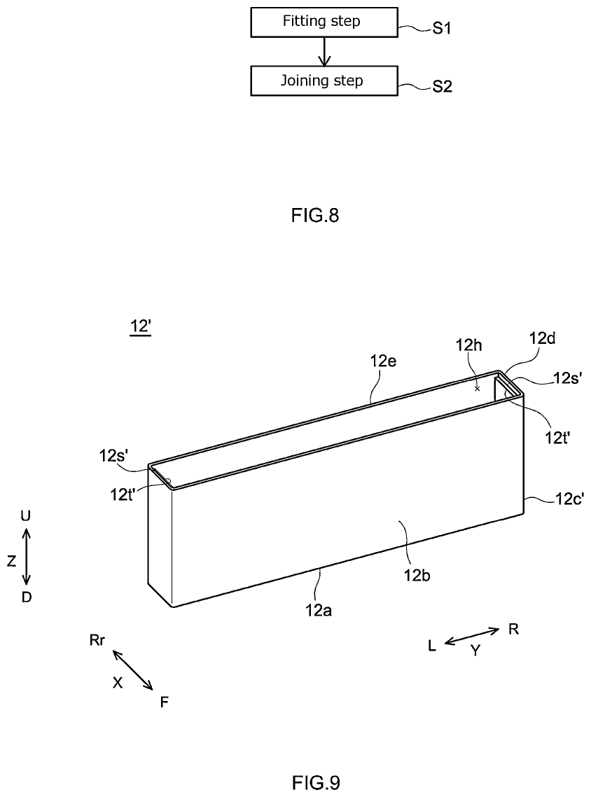

FIG. 8 is a flowchart that is for explaining the manufacturing method of the battery in accordance with the present embodiment. As shown in FIG. 8, the manufacturing method of the battery in accordance with the present embodiment includes a fitting step (step S1) and a joining step (step S2). Below, each of the steps will be described.

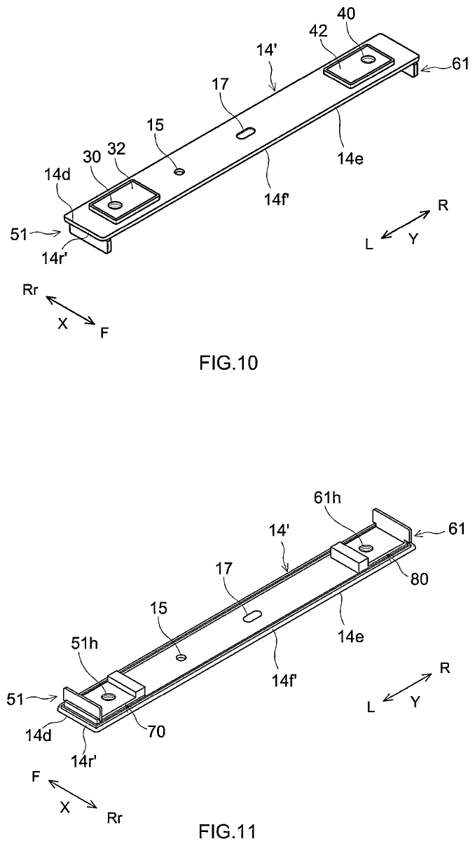

At first, the sealing plate 14′ (see FIG. 5), to which the electrode body (here, electrode body group 20) is attached, and the outer package 12′ (see FIG. 9) are prepared. Here, a composite product (hereinafter, referred to as “second composite product”, too) of FIG. 5 is manufactured after a composite product (hereinafter, referred to as “first composite product”, too) of FIG. 10 is manufactured, by making the first composite product be attached with an electrode body as shown in FIG. 6 on which the positive electrode second electrical collector part and the negative electrode second electrical collector part are attached.

For manufacturing the first composite product, at first, it is performed on the sealing plate 14′ to attach the positive electrode terminal 30, the positive electrode first electrical collector part 51, the positive electrode inside insulating member 70, the negative electrode terminal 40, the negative electrode first electrical collector part 61, and the negative electrode inside insulating member 80 (see FIG. 10 and FIG. 11). Then, the positive electrode terminal 30, the positive electrode first electrical collector part 51, and the positive electrode inside insulating member 70 are fixed to the sealing plate 14′, for example, by a caulking process (riveting). The caulking process is performed, while the gasket 90 is sandwiched between the outside surface of the sealing plate 14′ and the positive electrode terminal 30 and furthermore the positive electrode inside insulating member 70 is sandwiched between the inside surface of the sealing plate 14′ and the positive electrode first electrical collector part 51. Incidentally, a material of the gasket 90 might be similar to a material of the positive electrode inside insulating member 70. For more details, the positive electrode terminal 30 before the caulking process is inserted from an upward of the sealing plate 14′ into the penetration hole of the gasket 90, the terminal insert hole 18 of the sealing plate 14′, the penetration hole of the positive electrode inside insulating member 70, and the penetration hole 51h of the positive electrode first electrical collector part 51 in this order so as to be protruded to a downward of the sealing plate 14′. Then, to add compression force with respect to the vertical direction Z, caulking is performed on a portion of the positive electrode terminal 30 protruding to the downward more than the sealing plate 14′. Thus, a caulked part is formed at a tip end part (lower end part in FIG. 2) of the positive electrode terminal 30. By the caulking process as described above, the gasket 90, the positive electrode inside insulating member 70, and the positive electrode first electrical collector part 51 are integrally fixed to the sealing plate 14′ and the terminal insert hole 18 is sealed. Incidentally, the caulked part might be welded and joined to the positive electrode first electrical collector part 51. By doing this, it is possible to furthermore enhance the conduction reliability.

Fixing the negative electrode terminal 40, the negative electrode first electrical collector part 61, and the negative electrode inside insulating member 80 can be implemented similarly to fixing at the above-described positive electrode side. In other words, the negative electrode terminal 40 before the caulking process is inserted from an upward of the sealing plate 14′ into the penetration hole of the gasket, the terminal insert hole 19 of the sealing plate 14′, the penetration hole of the negative electrode inside insulating member 80, and the penetration hole 61h of the negative electrode first electrical collector part 61 in this order so as to be protruded to a downward of the sealing plate 14′. Then, to add compression force with respect to the vertical direction Z, caulking is performed on a portion of the negative electrode terminal 40 protruding to the downward more than the sealing plate 14′. Thus, a caulked part is formed at a tip end part (lower end part in FIG. 2) of the negative electrode terminal 40. By doing this as described above, it is possible to obtain the first composite product.

Next, the second composite product is manufactured. In other words, the electrode body group 20 integrated with the sealing plate 14′ is manufactured. In particular, firstly, as shown in FIG. 6, three electrode bodies 20a, while the positive electrode second electrical collector part 52 and the negative electrode second electrical collector part 62 are attached to each of three electrode bodies, are prepared as electrode bodies 20a, 20b, 20c to be arranged so as to be aligned in the short side direction X. At that time, the electrode bodies 20a, 20b, 20c might be arranged in parallel to make the positive electrode second electrical collector part 52 of each electrode body be arranged at one side (left side in FIG. 5) in the long side direction Y and to make the negative electrode second electrical collector part 62 of each electrode body be arranged at the other side (right side in FIG. 5) in the long side direction Y.

Next, while the plurality of positive electrode tabs 22t are in a state of being bent as shown in FIG. 4, the positive electrode first electrical collector part 51 fixed to the sealing plate 14′ and each positive electrode second electrical collector part 52 of the electrode bodies 20a, 20b, 20c are joined. In addition, while the plurality of negative electrode tabs 24t are in a state of being bent, the negative electrode first electrical collector part 61 fixed to the sealing plate 14′ and each negative electrode second electrical collector part 62 of the electrode bodies 20a, 20b, 20c are joined. As the joining method, for example, it is possible to use welding, such as ultrasonic welding, resistance welding, and laser welding. Particularly, it is preferable to use welding with the high energy ray irradiation, such as laser. By the welding process as described above, a join part is formed on each of a recessed part of the positive electrode second electrical collector part 52 and a recessed part of the negative electrode second electrical collector part 62. By doing this as described above, it is possible to obtain the second composite product.

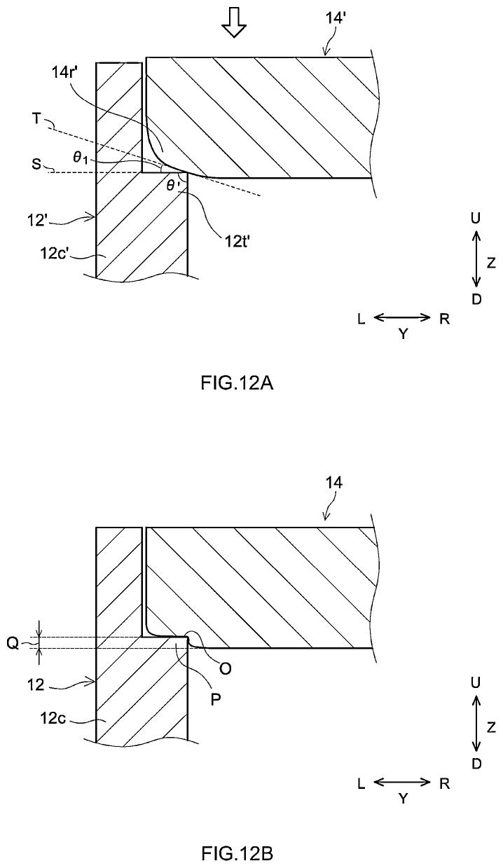

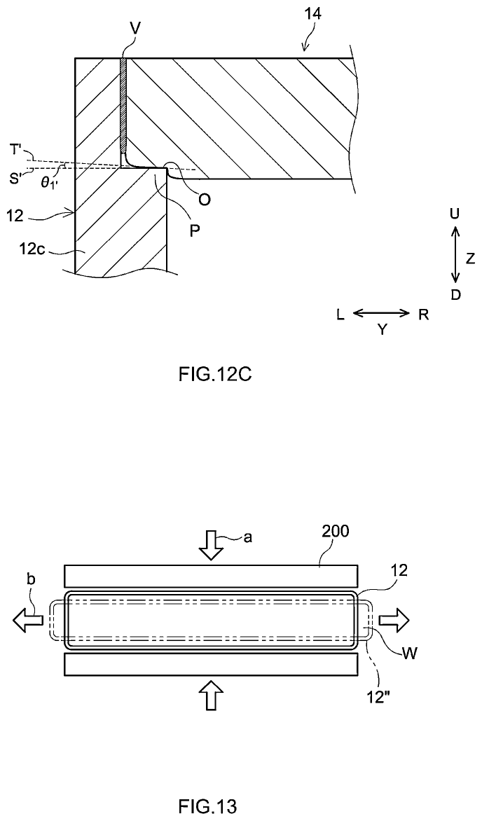

Here, configurations of the outer package 12′ before fitting (hereinafter, simply referred to as “outer package 12′”, too) and of the sealing plate 14′ will be described. FIG. 9 shows the outer package 12′, and FIG. 10 shows the sealing plate 14′. As shown in FIG. 9, the outer package 12′ includes a step part 12s′ having a corner part 12t′, at a vicinity of the opening part 12h on the second side wall 12c′ before fitting (hereinafter, simply referred to as “second side wall 12c′”, too). In addition, as shown in FIG. 10, the sealing plate 14′, at a portion opposed to the bottom wall 12a, includes a pair of R side walls 14′ having bent surfaces (R surfaces) and a pair of other side walls 14f′. The R side walls 14r′ are present at a short side 14d side of the sealing plate 14′. The outer package 12′ and the sealing plate 14′ as described above can be manufactured, for example, by molding with metal mold, or the like (the outer packages 112′, 212′ and the sealing plates 114′, 214′ described below are also similarly manufactured). Incidentally, in the present embodiment, an angle θ′ defined by the corner part 12t′ is about 90°, but is not restricted by this, and thus the angle defined by the corner part can be, for example, about 75° to 105°. However, the angle defined by the corner part is not particularly restricted if the effects of the technique herein disclosed are implemented. In addition, a thickness of the step part 12s′ in a thickness direction (in other words, width in Y direction of FIG. 12A) can be suitably planned, on a basis of a kind of the material configuring the outer package, use form, or the like. The plan as described above can be implemented by making a person skilled in the art perform a test, or the like.

(Fitting step: S1)

At the fitting step (step S1) in accordance with the present embodiment, by abutting at least a portion of the outer package 12′ and the sealing plate 14′ and by deforming the sealing plate 14′, the outer package 12′ and the sealing plate 14′ are fit. In addition, at the fitting step as described above, at least a portion of the sealing plate 14′ is arranged in the opening part 12h of the outer package 12′ so as to perform fitting.

FIG. 12A is a cross sectional view that is schematically shown for explaining about abutting the outer package 12′ and the sealing plate 14′. More particularly, it is a longitudinal cross section view that schematically shows an aspect of a cross section along a XII-XII line of FIG. 1 before fitting. As shown in FIG. 12A, at the fitting step S1 of the manufacturing method of the battery in accordance with the present embodiment, at least a portion of the outer package 12′ and the sealing plate 14′ are abutted. Here, θ₁ in FIG. 12A represents an acute angle defined by a line S drawn to a direction (in other words, Y direction of FIG. 1) in which the bottom wall 12a extends, and by a tangential line T at a portion where the R side wall 14r′ including the R surface and the corner part 12t′ included by the step part 12s′ come into contact. A value of the above-described acute angle θ₁ is not particularly restricted if the effects of the technique herein disclosed are implemented. The above-described acute angle θ₁ is, from a perspective of suitably suppressing stress concentration from being generated at the abutting part when fitting is performed, preferably 5° or more, further preferably 10° or more, or furthermore preferably 20° or more. An upper limit of the above-described acute angle θ can be, from a perspective of suitably suppressing a sputter from being generated by scraping the abutting parts to each other when fitting is performed, preferably 50° or less, further preferably 45° or less, or furthermore preferably 40° or less. It is possible to make the above-described acute angle θ₁ be within a range, for example, 10° to 45°.

FIG. 12B is a cross sectional view that is schematically shown for explaining the fit of the outer package 12′ and the sealing plate 14′. In further particular, it is a longitudinal cross section view that schematically shows an aspect of a cross section along a XII-XII line of FIG. 1 after fitting but before joining. At the fitting step in accordance with the present embodiment, by deforming the sealing plate 14′, the outer package 12′ and the sealing plate 14′ are fit. As shown in FIG. 12A, the deformation as described above is performed, for example, by pressing and fitting the sealing plate 14′ with respect to the outer package 12′ in a void arrow direction. Pressing and fitting as described above can be performed by a press-fit apparatus, or the like. A press-fit load at the time of performing press-fit is not particularly restricted if the effects of the technique herein disclosed are implemented. The press-fit load as described above is depending on the materials configuring the outer package and the sealing plate, but can be, for example, approximately about 50 N to 300 N (for example, about 100 N to 200 N) when the outer package 12′ and the sealing plate 14′ having configurations as described above are used. Incidentally, in a case where materials configuring the outer package 12′ and the sealing plate 14′ are selected from materials other than the above-described ones, a person skilled in the art can perform a preliminary test so as to suitably decide the press-fit load.

In addition, as shown in FIG. 12B, after the fitting step in accordance with the present embodiment, a fit part P is formed. The fit part P here includes a recessed part O that is formed by the corner part 12t′ included by the step part 12s′. A depth Q of the recessed part O (in other words, bitten depth in Z direction of FIG. 12B) in a thickness direction of the sealing plate 14 is not particularly restricted if the effects of the technique herein disclosed are implemented. The above-described depth Q can be, from a perspective of suitably fixing the sealing plate 14 with respect to the outer package 12, preferably 0.01 mm or more, further preferably 0.05 mm or more, or furthermore preferably 0.1 mm or more. The above-described depth Q can be, from a perspective of making the stress on the sealing plate 14 be appropriate and suitably suppressing degradation of a join part V described later, preferably 0.5 mm or less, further preferably 0.4 mm or less, or furthermore preferably 0.3 mm or less. For example, the depth Q can be within a range of 0.01 mm to 0.3 mm Incidentally, the thickness of the sealing plate 14 in accordance with the present embodiment is about 2.8 mm.

(Joining step: S2)

At the joining step (step S2) in accordance with the present embodiment, the outer package 12 and the sealing plate 14 are joined. More particularly, the sealing plate 14 is joined to the edge part of the opening part 12h of the outer package 12 so as to seal the opening part 12h. Welding and joining the outer package 12 and the sealing plate 14 can be implemented, for example, by laser welding, or the like.

Additionally, in the present embodiment, a press member 200 as shown in FIG. 13 is used to perform joining. Incidentally, FIG. 13 shows only the outer package 12 to facilitate explanation. Here, for example, about a battery including the outer package in which an area of the first side wall is larger than an area of the second side wall (for example, outer package including a rectangular opening part), as an example for a method of obtaining a battery whose reliability is enhanced, it is possible to use a method of joining while inhibiting a gap of the join part with the outer package and the sealing plate from being generated at a side of the long side of the opening part. Thus, in the present embodiment, by pressing the pair of first side walls 12b to an inside of the outer package 12 (see arrow a), the outer package 12 and the sealing plate 14 are joined while generation of the gap of the join part is suppressed. However, when pressing is performed to the arrow a, the outer package 12 might be deformed in a direction of an arrow b and thus a gap W might be generated at a side of the short side 12d of the outer package (see outer package 12″ of FIG. 13). In that case, the sputter, or the like capable of being generated at the time of joining might enter from the gap W into the outer package 12″. On the other hand, in the present embodiment, at least on the side of short side 14d of the sealing plate 14, the outer package 12 and the sealing plate 14 are fit, thus the gap W is hardly generated at the side of short side 12d of the outer package, and therefore it is possible to suitably inhibit the sputter from entering into the outer package.

FIG. 12C is a cross sectional view that schematically shows an aspect after the outer package 12 and the sealing plate 14 are joined. FIG. 12C is a longitudinal cross section view that is schematically shown along a XII-XII line of FIG. 1. Here, a depth of the join part V (in other words, depth of the join part V in Z direction of FIG. 12C) is not particularly restricted if the effects of the technique herein disclosed are implemented. It is preferable that the depth of the above-described join part V is formed from a surface of the sealing plate 14 to the fit part P. For example, the depth of the above-described join part V can be formed in a range of approximately 30% to 70% (for example, 40% to 60%) from the surface of the sealing plate 14 in a case where a distance from a surface of the sealing plate to the fit part P is treated as 100%.

By injecting the electrolyte from the liquid injection hole 15 and covering the liquid injection hole 15 with the sealing member 16 after the above-described joining step, the battery 100 is sealed. As described above, it is possible to manufacture the battery 100. In addition, the battery 100, obtained by the manufacturing method of the battery in accordance with the present embodiment, includes features as described below.

As explained above, the battery 100 obtained by the manufacturing method of the battery in accordance with the present embodiment includes the fit part P formed by making at least a portion of the outer package 12 bite at least a portion of the sealing plate 14 (see FIG. 12C). In addition, the fit part P includes a recessed part O. Here, θ₁′ of FIG. 12C represents an acute angle defined by a line S′ drawn in a direction in which the bottom wall 12a extends (in other words, Y direction in FIG. 1) and a tangential line T′ on the recessed part O. For example, when the outer package 12′ and the sealing plate 14′ are abutted to make the acute angle θ₁ be within a range of 10° to 45°, the acute angle θ₁′ on the fit part P formed after the fitting step can be within the range of 10° to 45°.

In addition, for example, when the outer package 12′ and the sealing plate 14′ are fit to make the depth Q be within a range of 0.01 mm to 0.3 mm, the recessed part O can be formed on the fit part P and the depth of the recessed part O in the thickness direction of the sealing plate 14 can be within the range of 0.01 mm to 0.3 mm.

Additionally, in the present embodiment, when the sealing plate 14′ is pressed and fit in the void arrow direction with respect to the outer package 12′, press-fit is performed in which a center portion (typical, meaning an area about 10 to 20% from the center of the short side 12d when a length of the short side is treated as 100%) is easily pressed and fit more than both end parts at a side of the short side 12d of the outer package 12′. Therefore, in the present embodiment, on the fit part P formed at the side of the short side 12d, a deeper bitten site can be confirmed at a center part than both end parts.

Above, some embodiments of the present disclosure are explained, but the above described embodiments are merely examples. The present disclosure can be implemented in various other forms. The present disclosure can be executed based on the contents disclosed in the present specification, and the technical common sense in the present field. The technique recited in the appended claims includes variously deformed or changed versions of the embodiments that have been illustrated above. For example, one part of the above described embodiment can be replaced with another deformed embodiment, and furthermore another deformed embodiment can be added to the above described embodiment. In addition, unless a technical feature is explained to be essential, this technical feature can be appropriately deleted.

For example, in the above-described embodiment, a situation was explained where the battery case was a square shaped battery case including an opening part formed in a rectangle, but the present disclosure is not restricted to this. The herein disclosed technique can be applied, for example, for a square shaped battery case including an opening part formed in a square shape, a battery case formed in a column shape, or other various battery cases.

For example, in the above-described embodiment, a situation was explained where fitting was performed only at the sealing plate and the side of the short side of the outer package, but the present disclosure is not restricted to this. In the herein disclosed technique, fitting might be performed, for example, only at one of short sides among the sides of short sides of the sealing plate and the outer package (a pair of short sides). Additionally, in the herein disclosed technique, fitting might be performed, for example, only at the sides of long sides of the sealing plate and the outer package, or might be performed at both sides among the sides of short sides and the sides of long sides of the sealing plate and the outer package.

For example, in the above-described embodiment, the R surface (R side wall) is formed at the whole of the pair sides of short sides of the sealing plate, but the present disclosure is not restricted to this. For example, the R surface (R side wall) might be formed at a portion of the side of short side of the sealing plate, if the effects of the technique herein disclosed are implemented. When a length of the short side of the sealing plate (length of the short side) is treated as 100%, the R surface (R side wall) might be formed within a range of approximately 20% or more, preferably 30% or more, 40% or more, 50% or more, 60% or more, or 70% or more, at one short side. About the short side, a similar configuration can be applied, too. In addition, when a length of whole circumference of the sealing plate is treated as 100%, it is preferable that the R surface (R side wall) is formed on an area approximately 5 to 20%. Incidentally, regarding one short side (or, one long side) and the other short side (or, the other long side), rates of formed R side walls might be the same of different. Even in a case where a C surface or a corner part is formed on the sealing plate, a similar configuration might be applied. Additionally, in the above-described embodiment, an aspect was applied in which the deeper bitten site was confirmed particularly at the center portion on the side of short side of the outer package, but the present disclosure is not restricted to this, and thus the bitten site as described above might be uniformed on the side of short side.

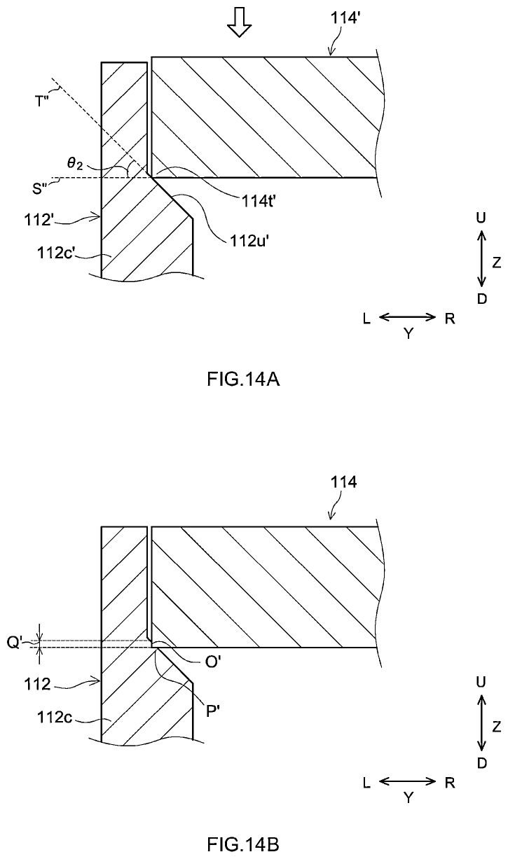

FIG. 14A is a FIG. 12A corresponding view in accordance with Embodiment 2, and FIG. 14B is a FIG. 12B corresponding view in accordance with Embodiment 2. As shown in FIG. 14A, at the fitting step in accordance with Embodiment 2, at least a portion of the second side wall 112c′ (hereinafter, simply referred to as “second side wall 112c′”, too) of the outer package 112′ before fitting (hereinafter, simply referred to as “outer package 112′”, too) and the sealing plate 114′ before fitting (hereinafter, simply referred to as “sealing plate 114′”, too) are abutted. Here, the second side wall 112c′ includes a side wall 112u′ including a C surface and including an inclination. In addition, the sealing plate 114′ includes a corner part 114t′. Here, a θ₂ of FIG. 14A represents an acute angle defined by a line S″ drawn to a direction in which the bottom wall 12a extends (in other words, Y direction of FIG. 1) and by a tangential line T″ at a portion where the side wall 112u′ and the corner part 114t′ come into contact with each other. A value of the above-described acute angle θ₂ is not particularly restricted if the effects of the technique herein disclosed are implemented, but can be within a range, for example, as described for explaining the above-described acute angle θ₁.

Additionally, as shown in FIG. 14A, regarding Embodiment 2, by deforming the outer package 112′ (in particular, second side wall 112c′), the outer package 112′ and the sealing plate 114′ are fit. The deformation as described above can be performed, for example, by making the sealing plate 114′ be pressed and fit in the void arrow direction with respect to the outer package 112′. The press-fit as described above can be implemented, for example, by a press-fit apparatus, or the like. A press-fit load for performing the press-fit can be decided, for example, by referring to the above-described explanation. In addition, as shown in FIG. 14B, a fit part P′ having been formed after the fitting step includes a recessed part O′, and a depth Q′ of the recessed part in the thickness direction of the sealing plate 114 (in other words, a bitten depth in Z direction of FIG. 14B) can be, for example, similar to the above-described Q. Then, by joining similarly to the above-described embodiment, it is possible to obtain a battery in which the outer package 112 (in particular, second side wall 112c) and the sealing plate 114 are fit.

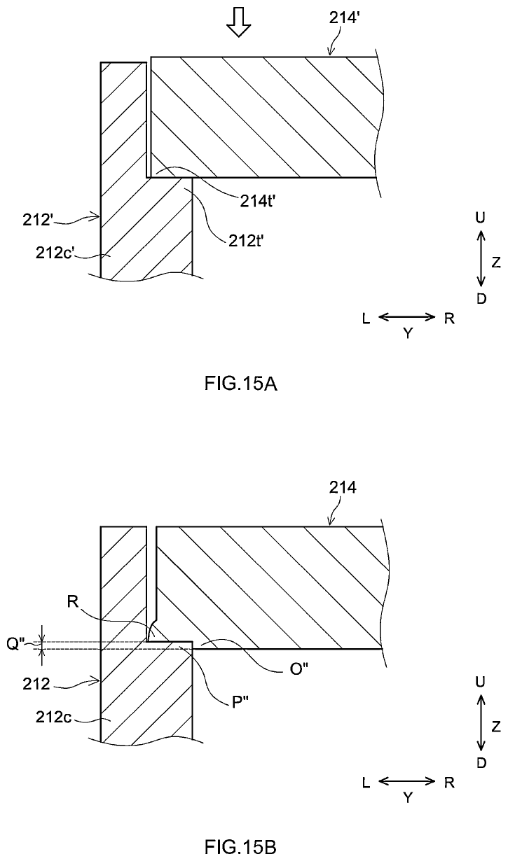

FIG. 15A is a FIG. 12A corresponding view in accordance with Embodiment 3, and FIG. 15B is a FIG. 12B corresponding view in accordance with Embodiment 3. As shown in FIG. 15A, at the fitting step in accordance with Embodiment 3, at least a portion of the second side wall 212c′ (hereinafter, simply referred to as “second side wall 212c′”, too) of the outer package 212′ before fitting (hereinafter, simply referred to as “outer package 212′”, too) and the sealing plate 214′ before fitting (hereinafter, simply referred to as “sealing plate 214′″, too) are abutted. Here, the second side wall 212c′ includes a corner part 212t′, and the outer package 212′ includes a corner part 214t′.

In addition, as shown in FIG. 15A, regarding Embodiment 3, by deforming the corner part 212t′ of the sealing plate 214′, the outer package 212′ and the sealing plate 214′ are fit. The deformation as described above can be performed, for example, by making the sealing plate 214′ be pressed and fit in the void arrow direction with respect to the outer package 212′. The press-fit as described above can be implemented, for example, by a press-fit apparatus, or the like. A press-fit load for performing the press-fit can be decided, for example, by referring to the above-described explanation. In addition, as shown in FIG. 15B, a fit part P″ having been formed after the fitting step includes a recessed part O″, and a depth Q″ of the recessed part in the thickness direction of the sealing plate 214 (in other words, a bitten depth in Z direction of FIG. 15B) can be, for example, similar to the above-described Q. Incidentally, in Embodiment 3, a padding part R is disposed at a vicinity of the fit part P″ on a bitten site (here, sealing plate 214). Then, by joining similarly to the above-described embodiment, it is possible to obtain the battery in which the outer package 212 (in particular, second side wall 212c) and the sealing plate 214 are fit.

1. A manufacturing method of a battery, the battery comprising:
one or a plurality of electrode bodies each provided with a positive electrode and a negative electrode; and
a battery case that is configured to accommodate the electrode body and comprises an outer package and a sealing plate configured to seal an opening part of the outer package,
the manufacturing method comprising:
a fitting step for abutting at least one portion of the outer package and the sealing plate and for deforming the outer package and/or the sealing plate so as to fit the outer package and the sealing plate; and
a joining step for joining the outer package and the sealing plate.

2. The manufacturing method of the battery according to claim 1, wherein
the outer package comprises a bottom wall, a pair of first side walls that extend from the bottom wall and are opposed mutually, a pair of second side walls that extend from the bottom wall and are opposed mutually, and an opening part that is opposed to the bottom wall, an area of the first side wall is larger than the second side wall, and
the sealing plate is formed in a rectangular shape.

3. The manufacturing method of the battery according to claim 2, wherein
at the fitting step, at least a portion of the sealing plate is arranged inside the opening part of the outer package so as to perform the fitting, and
at the joining step, the outer package and the sealing plate are joined while the pair of first side walls are pressed to an inside of the outer package.

4. The manufacturing method of the battery according to claim 2, wherein
at the fitting step, the outer package and the sealing plate are fit on at least a side of short side of the rectangular sealing plate.

5. The manufacturing method of the battery according to claim 1, wherein
any one among the at least one portion of the outer package and the sealing plate to be abutted comprises a R surface or a C surface, and
other one to be abutted comprises a corner part for deforming the R surface or the C surface.

6. The manufacturing method of the battery according to claim 5, wherein
the R surface or the C surface exists at a portion opposed to the bottom wall on the sealing plate.

7. The manufacturing method of the battery according to claim 5, wherein
a step part comprising the corner part exists at a vicinity of the opening part on the outer package.

8. The manufacturing method of the battery according to claim 5, wherein
at the fitting step, the at least one portion of the outer package and the sealing plate are abutted to make an acute angle, defined by a direction in which the bottom wall extends and by a tangential line at a portion where the R surface or the C surface and the corner part come into contact with each other, be within a range of 10° to 45°.

9. The manufacturing method of the battery according to claim 5, wherein
at the fitting step, a fit part is formed, and the fit part comprises a recessed part formed by the corner part to make a depth in a thickness direction of the sealing plate be within a range of 0.01 mm to 0.3 mm.

10. A battery comprising:
one or a plurality of electrode bodies, each provided with a positive electrode and a negative electrode; and
a battery case configured to accommodate the electrode body, and provided with an outer package and a sealing plate that is configured to seal an opening part of the outer package, wherein
a fit part exists in which any one among at least one portion of the outer package and at least one portion of the sealing plate is bitten by other one, and
the outer package and the sealing plate are joined.

11. The battery according to claim 10, wherein
a padding part exists at a vicinity of the fit part of the bitten one among the at least one portion of the outer package or the at least one portion of the sealing plate.

12. The battery according to claim 10, wherein
the fit part comprises a recessed part, and an acute angle defined by a direction in which the bottom wall extends and by a tangential line at the recessed part is within a range of 10° to 45°.

13. The battery according to claim 10, wherein
the fit part comprises a recessed part in which a depth in a thickness direction of the sealing plate is within a range of 0.01 mm to 0.3 mm.
